(19) United States
(12) Patent Application Publication
(10) Pub. No.: US 2011/0182095 A1
(43) Pub. Date: Jul. 28, 2011

(54) PACKAGE FOR SYNCHRONOUS RECTIFIER MODULE

(76) Inventors: Eric Yang, Saratoga, CA (US); Yuancheng Ren, Hangzhou (CN); Junming Zhang, Hangzhou (CN); Lei Miao, Hangzhou (CN)

(21) Appl. No.: 13/010,528

(22) Filed: Jan. 20, 2011

(30) Foreign Application Priority Data
Jan. 22, 2010 (CN) 201020301258.2

(51) Int. Cl. H02M 7/217

(52) U.S. Cl. 363/127

(57) ABSTRACT

The present technology discloses a package for a synchronous rectifier module, and also discloses synchronous rectification circuits and power supply adapters. The synchronous rectification circuit co-packages the synchronous rectifier and the driver into one single package. The single package simplifies the external circuitry and reduces potential electromagnetic interferences.

### CROSS-REFERENCE TO RELATED APPLICATION(S)

This application claims the benefit of Chinese patent application No. 201020301258.2, filed on Jan. 22, 2010, the disclosure of which is incorporated herein by reference is its entirety.

### TECHNICAL FIELD

The present technology relates generally to voltage converters, and more particularly, relates to packages of a synchronous rectifier module of an isolated converter system.

### BACKGROUND

Generally speaking, two rectifying schemes are adopted in the secondary side of a fly-back converter. One is non-synchronous rectification which adopts a diode D (FIG. 1A). And another is synchronous rectification which rectifies the current through controlling on/off of a synchronous rectifier Q, e.g., an N-MOSFET (FIG. 1B). The voltage-current characteristic is plotted in FIG. 1C, for the diode D (curve 12) and for the synchronous rectifier Q (curve 11). In practical applications, the work area of a low power fly-back power converter typically falls into the shadow area. The resistance of the synchronous rectifier Q is typically less than that of the diode D in the area because curve 11 is always above curve 12. So, compared with a diode, a scheme with a synchronous rectifier is more preferable for lower power consumption and better efficiency. Such a scheme thus finds increasingly wide applications in equipment sensitive to efficiency such as laptop adapters, wireless equipment, LCD power management modules and so on.

However, the synchronous rectifying scheme requires a synchronous rectification driver to control the rectifier Q. The synchronous rectifier under the control of the driver functions as the diode with low resistance and high efficiency. Usually, two separate packages for the synchronous rectifier and the driver are adopted with additional external components. This results in a complicated system and introduced EMI (Electro Magnetic Interference) because of the signal transmission between the different packages. Thus, a simpler system may be desirable for synchronous rectification.

### SUMMARY

In one embodiment, a package for a synchronous rectifier module comprises a first lead, a second lead, a third lead, a driver die and a synchronous rectifier die. The driver die comprises a first input contact pad, a second input contact pad, a power supply contact pad and an output contact pad. The synchronous rectifier die comprises a source region, a drain region and a gate region. And the first lead is coupled to the source region and to the first input contact pad. The second lead is coupled to the drain region and to the second input contact pad. The third lead is coupled to the power supply contact pad.

In another embodiment, a synchronous rectification circuit comprises a secondary winding of a transformer, an output node configured to deliver an output signal and a synchronous rectifier module. The package of the synchronous rectifier module comprises a first lead, a second lead and a third lead. The first lead is externally coupled to the first end of the secondary winding. The second lead is externally coupled to the output node. A power supply source is coupled between the first lead and the third lead. The other end of the secondary winding is coupled to the secondary ground. In a further embodiment, the second lead is externally coupled to the secondary ground, and the other end of the secondary winding is coupled to the output node.

In a yet further embodiment, a power supply adapter comprises a smart driver in a single package. The smart driver comprises a synchronous rectifier and a driver. The synchronous rectifier is coupled between the secondary winding of an isolated converter and the output of the isolated converter. The driver delivers a gate driving signal to the control end of the synchronous rectifier for controlling the switching function of the synchronous rectifier.

### BRIEF DESCRIPTION OF THE DRAWINGS

Non-limiting and non-exhaustive embodiments are described with reference to the following drawings. The drawings are only for illustration purposes. Usually, the drawings only show part of the circuits/devices of the embodiments. These drawings are not necessarily drawn to scale. The relative sizes of elements illustrated by the drawings may differ from the relative size depicted.

FIG. 1A shows a diode D used as a non-synchronous rectifier in accordance with the prior art.

FIG. 1B shows a MOSFET Q used as a synchronous rectifier in accordance with the prior art.

FIG. 1C shows a voltage-current curve for the non-synchronous rectifier D of FIG. 1A and the synchronous rectifier Q of FIG. 1B in accordance with the prior art.

FIG. 2 shows a synchronous rectification circuit according to one embodiment of the present technology.

FIG. 3 shows another synchronous rectification circuit according to another embodiment of the present technology.

FIG. 4 shows yet another synchronous rectification circuit comprising a synchronous rectifier module according to one embodiment of the present technology.

FIG. 5A is a plan view showing a package system of a synchronous rectifier module according to one embodiment of the present technology.

FIG. 5B is a cross-sectional view of the package system in FIG. 5A.

FIG. 6A shows a package system of a synchronous rectifier module according to another embodiment of the present technology.

FIG. 6B is a cross-sectional view of the package system in FIG. 6A.

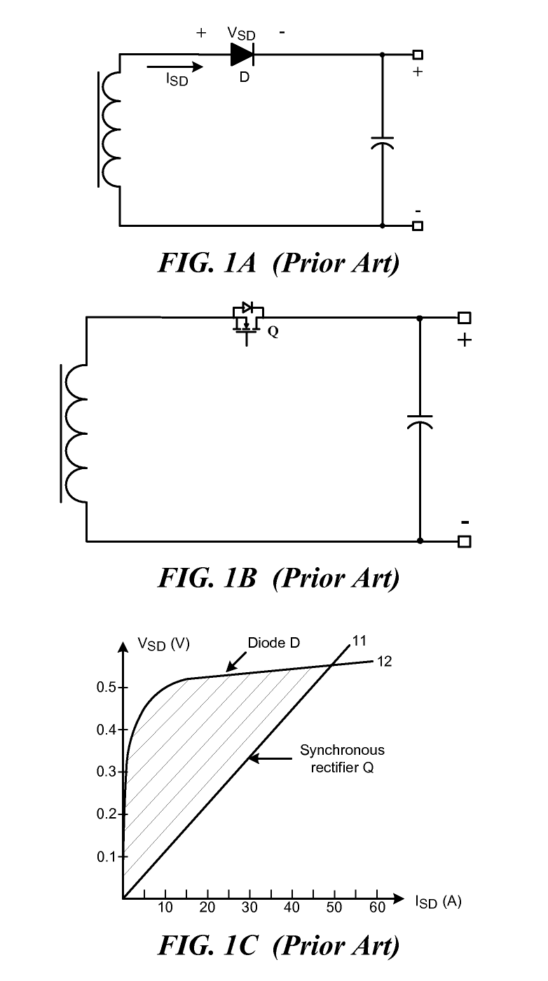

### DETAILED DESCRIPTION

The following description provides a description for certain embodiments of the technology. One skilled in the art will understand that the technology may be practiced without some of the features described herein. In some instances, well known structures and functions have not been shown or described in detail to avoid unnecessarily obscuring the description of the embodiments of the technology. In other instances, similar structures and functions that have been described in detail for other embodiments have not been described in detail for such embodiments to simplify and ease understanding.

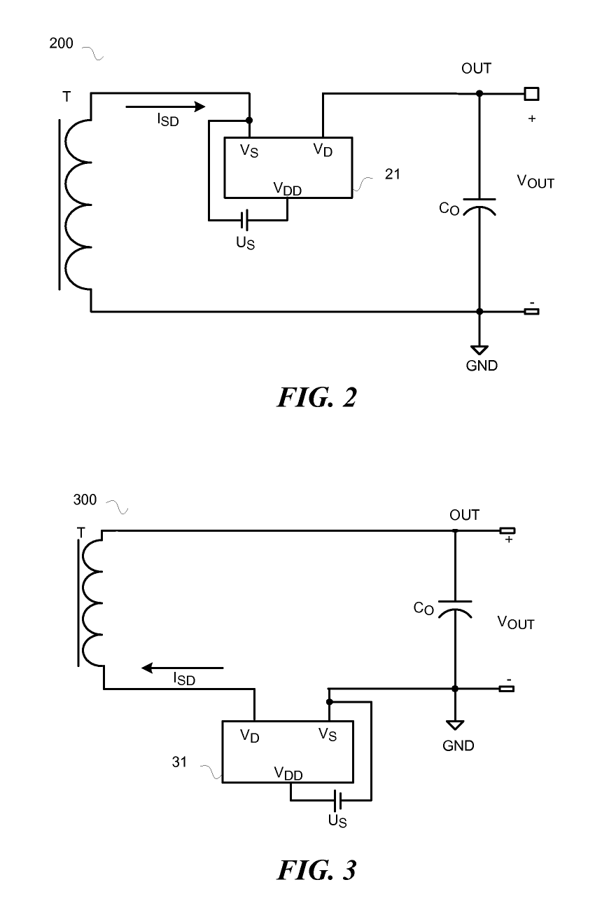

FIG. 2 shows a synchronous rectification circuit 200 according to one embodiment of the present technology. The synchronous rectification circuit 200 and other synchronous rectification circuits described below can be used in a fly-back converter system or other suitable systems. For purposes of clarity, a complete description of the fly-back converter system or other suitable systems is omitted though embodiments of the current technology may include certain components of such systems.

As shown in FIG. 2, the synchronous rectification circuit 200 includes a synchronous rectifier module 21 to perform synchronous rectification. The synchronous rectifier module 21 comprises three external nodes including the first node V_{S}, the second node V_{D} and the third node V_{DD}. The synchronous rectification circuit 200 further comprises a secondary winding T, an output node OUT delivering output signal V_{OUT} for supplying a load, a secondary ground node GND, and an output capacitor C_{O} The output capacitor C_{O} is coupled between the output node OUT and the secondary ground node GND. The synchronous rectifier module 21 has the first node V_{S} coupled to the first end of the secondary winding T for receiving the drain-source current I_{SD} and has the second node V_{D} coupled to the output node OUT. A power supply source U_{S} is coupled between the first node V_{S} and the third node V_{DD} to supply the synchronous rectifier module 21. The other end of the secondary winding T is connected to the secondary ground GND.

FIG. 3 shows another synchronous rectification circuit 300 according to an embodiment of the present technology. The synchronous rectification circuit 300 is similar to the synchronous rectification circuit 200 of FIG. 2 except that the synchronous rectifier module 31 in circuit 300 is a low-side rectifier while the synchronous rectifier module 31 in circuit 200 is a high-side rectifier. The synchronous rectifier module 31 in circuit 300 has the first node V_{S} coupled to the secondary ground GND, and has the second node V_{D} coupled to one end of the secondary winding T for receiving the drain-source current I_{SD}, while the other end of the secondary winding T is coupled to the output node OUT.

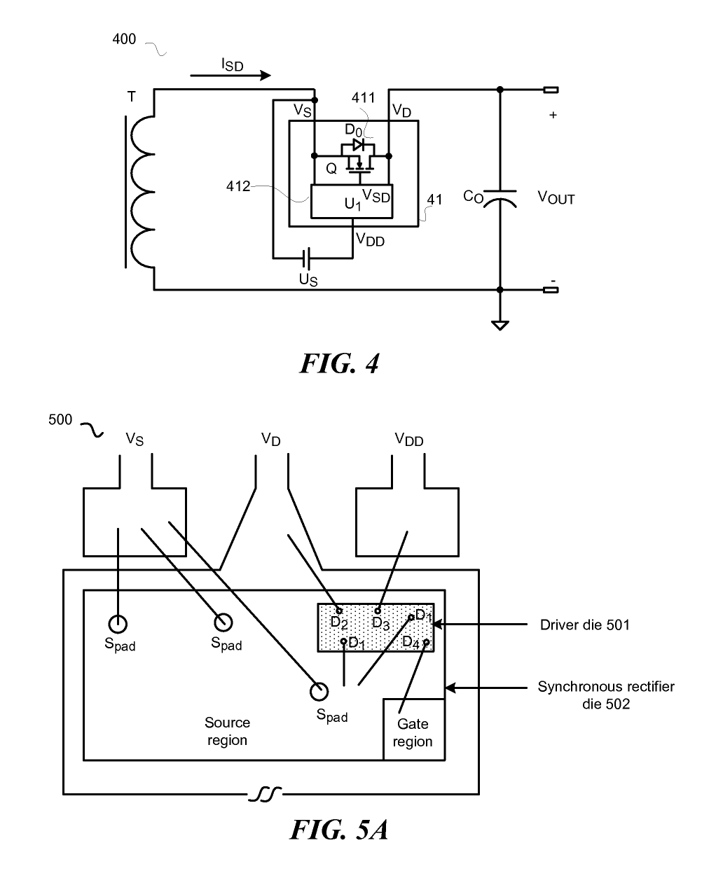

FIG. 4 shows an internal configuration of a synchronous rectifier module 41 in a synchronous rectification circuit 400 according to one embodiment of the present technology. As shown in FIG. 4, the synchronous rectifier module 41 comprises a synchronous rectifier 411 (Q) and a driver 412 (U1) coupled to the control end of the synchronous rectifier 411 for controlling the switching action of synchronous rectifier 411. The synchronous rectifier 411 is an N type MOSFET (Metal Oxide Semiconductor Field Effect Transistor) as shown in FIG. 4 and the control end is its gate. Yet in other embodiments, the synchronous rectifier 411 can include other types of Field Effect Transistor devices different than that shown in FIG. 4. The driver 412 is coupled to receive the source-drain voltage V_{SD} of the rectifier 411 and controls the rectifier 411 to function as a diode. In the illustrated embodiment, the driver 412 turns on the rectifier 411 when the body diode D₀ of the rectifier 411 is forward biased and turns off the rectifier 411 when the bias on the body diode D₀ of the rectifier 411 is reversed.

The first node V_{S} of the synchronous rectifier module 41 is coupled to the source of the synchronous rectifier 411 and to the first input of the driver 412. The second node V_{D} of 41 is coupled to the drain of the rectifier 411 and to the second input of the driver 412. And the third node V_{DD} of 41 is coupled to the power supply terminal of the driver 412. A power supply source U_{S} is coupled between the first node V_{S} and the third node V_{DD}. Furthermore, the output of the driver 412 is coupled to the gate of the synchronous rectifier 411 for providing the driving signal. With this configuration, the driver 412 automatically turns on or turns off the rectifier 411 according to the source-drain voltage V_{SD} of the rectifier 411.

Furthermore, the synchronous rectifier module 41 can be fabricated in a single package that co-packages the synchronous rectifier 411 and the driver 412. The term “co-package” as used hereinafter generally refers to packaging two or more dies in a single package. As a result, the synchronous rectifier module 41 only has three external pins for nodes V_{S}, V_{D} and V_{DD} respectively. This results in a simplified synchronous rectification system. Co-packaging of the synchronous rectifier 411 and the driver 412 shortens the signal transmission distances therebetween and thus can reduce power consumption and EMI when compared to conventional devices.

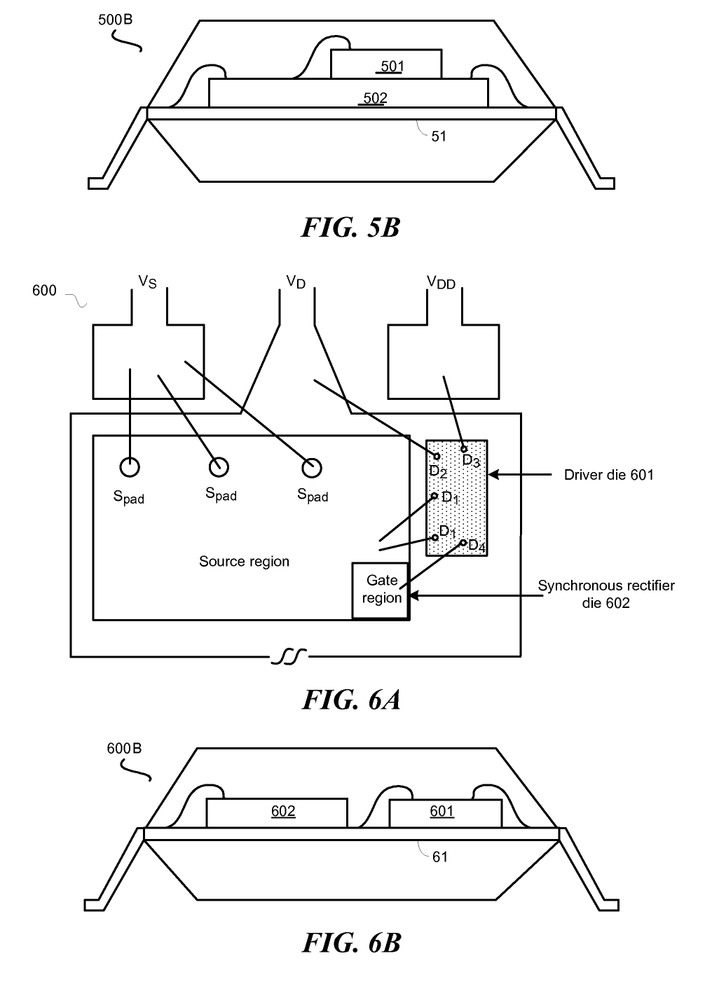

FIG. 5A shows a stacked die package 500 of the synchronous rectifier module U2 with one die attached on another die according to one embodiment of the present technology. A stacked die package comprises two or more dies in a single package with one die arranged vertically relative to other dies. The package 500 comprises a first die 501, a second die 502, a first lead V_{S}, a second lead V_{D} and a third lead V_{DD}. Each lead is partially exposed to form a corresponding pin. The first lead V_{S}, the second lead V_{D} and the third lead V_{DD} function as the first node V_{S}, the second node V_{D} and the third node V_{DD} of the synchronous rectifier module respectively, as shown in FIGS. 2-4.

The first die 501 and the second die 502 are stacked together. The first die 501 can be the driver die with a driver 412 (FIG. 4) fabricated on a semiconductor substrate and the second die 502 can be the synchronous rectifier die with the synchronous rectifier 411 (FIG. 4) fabricated on another semiconductor substrate. The synchronous rectifier die comprises the source region, the gate region and the drain region. The source region shown in FIG. 5A comprises multiple contact pads S_{pad} to assure high current carrying capability. The drain region is the opposite surface of the synchronous rectifier die and contacts the second lead V_{D} of the package 500 at the bottom surface of the synchronous rectifier die.

The driver die 501 is attached to the surface of the synchronous rectifier die 502. The driver die 501 comprises a first input contact pad D1, a second input contact pad D2, a power supply contact pad D3 and an output contact pad D4. The first lead V_{S} is coupled to the source region of the synchronous rectifier die 102 and the first input contact pad D1 of the driver die 501, and receives source signal of the synchronous rectifier die 502. The second lead V_{D} is coupled to the drain region of the synchronous rectifier die 502 and the second input contact pad D2 of the driver die 501, and receives the drain signal of the synchronous rectifier die 502. The third lead V_{DD} is coupled to the power supply contact pad D3 of the driver die 501, and receives the power supply source. The output contact pad D4 of the driver 501 is coupled to the gate region of the synchronous rectifier die 502, such that the driver die 501 delivers gate driving signal to the synchronous rectifier die 502. In the embodiment shown in FIG. 5A, the driver die 101 is placed on the surface of the source region of the synchronous rectifier die 502.

FIG. 5B illustrates a stacked die package 500B. As shown in FIG. 5B, the first die 501 is attached on the surface of the second die 502 and the second die 502 is attached on the surface of the lead frame structure 51 having a plurality of leads. Typically, to “couple” or “coupling” is achieved by bonding wires as the lines shown in FIG. 5A each having one end attached to a contact pad and the other end attached to the lead of the lead frame structure 51 though other electrical couplers (e.g., bumps, pins, etc.) may also be used in certain embodiments.

FIG. 6A shows a die-to-die package 600 according to one embodiment of the present technology. A die-to-die package comprises two or more dies arranged side by side on a substrate. In one embodiment, the die-to-die package 600 co-packages a synchronous rectifier and a driver of the synchronous rectifier module with the driver die 601 (or the first die 601) placed side by side with the synchronous rectifier die 602 (or the second die 602). FIG. 6B illustrates a sectional view of a die-to-die package 600B as one example in which the first die 601 and the second die 602 are positioned side by side, with both first and second dies 601 and 602 attached to the lead frame structure 61. For simplification, the connection relationship of the package 600 is not elaborated. The die-to-die package 600 is similar to the die-to-die package 500 except that the driver 601 is placed side by side with the synchronous rectifier die 602, not attached on the surface of the synchronous rectifier die 602, as in FIG. 5A. Though the packages shown in FIG. 5B and FIG. 6B are in SOP (Small Outline Package) packages, the packages can have other forms such as DFN (Dual Flat No leads) packages in other embodiments.

The multi-chip die packages 500 and/or 600 co-package the driver die 501/601 and the synchronous rectifier die 502/602 of a synchronous rectifier module in a single package. The distance of the signal transmission is substantially reduced when compared to conventional devices. Thus external circuitry for a fly-back converter system can be simplified and introduced EMI can be reduced.

From the foregoing, it will be appreciated that specific embodiments of the technology have been described herein for purposes of illustration, but that various modifications may be made without deviating from the technology. Many of the elements of one embodiment may be combined with other embodiments in addition to or in lieu of the elements of the other embodiments. Accordingly, the technology is not limited except as by the appended claims.

I/We claim:

1. A package for a synchronous rectifier module, comprising:
a first lead;
a second lead;
a third lead;
a driver die comprising a first input contact pad, a second input contact pad, a power supply contact pad, and an output contact pad; and
a synchronous rectifier die comprising a source region, a drain region, and a gate region, the synchronous rectifier die containing the synchronous rectifier module;
wherein said first lead is coupled to said source region and to said first input contact pad, and wherein said second lead is coupled to said drain region and to said second input contact pad, and further wherein said third lead is coupled to said power supply contact pad.

2. The package of claim 1, wherein said output contact pad is coupled to said gate region.

3. The package of claim 1, wherein said driver die and said synchronous rectifier die are co-packaged as a stacked die package.

4. The package of claim 1, wherein said synchronous rectifier is a field effect transistor device.

5. The package of claim 1, wherein said driver die and said synchronous rectifier die are co-packaged as a die-to-die package.

6. A synchronous rectification circuit, comprising:
a secondary winding of a transformer, the secondary winding having a first end and a second end;
an output node configured to deliver an output signal;
a secondary ground node;
a power supply source; and
a synchronous rectifier module in a package, said package having a first lead, a second lead, and a third lead;
wherein said first lead is externally coupled to the first end of said secondary winding, and wherein said second lead is externally coupled to said output node, and further wherein said power supply source is coupled between said first lead and said third lead, and yet further wherein the second end of said secondary winding is coupled to said secondary ground node.

7. The synchronous rectification circuit of claim 6, wherein said package further comprises:
a driver die comprising a first input contact pad, a second input contact pad, and a power supply contact pad;
a synchronous rectifier die comprising a source region, a drain region, and a gate region;
wherein said first lead is internally connected to said source region and to said first input contact pad, and wherein said second lead is internally connected to said drain region and to said second input contact pad, and further wherein said third lead is internally connected to said power supply contact pad.

8. The synchronous rectification circuit of claim 7, wherein said driver die further comprises an output contact pad internally connected to said gate region.

9. The synchronous rectification circuit of claim 7, wherein said driver die and said synchronous rectifier die are co-packaged as a stacked die package.

10. The synchronous rectification circuit of claim 7, wherein said driver die and said synchronous rectifier die is co-packaged as a die-to-die package.

11. A synchronous rectification circuit, comprising:
a secondary winding of a transformer, the secondary winding having a first end and a second end;
an output node configured to deliver an output signal;
a secondary ground node;
a power supply source; and
a synchronous rectifier module in a single package, wherein said package comprises a first lead, a second lead, and a third lead;
wherein said first lead is externally coupled to said secondary ground node, and wherein said second lead is externally coupled to the first end of said secondary winding, and further wherein said power supply source is coupled between said first lead and said third lead, and yet further wherein the second end of said secondary winding is coupled to said output node.

12. The synchronous rectification circuit of claim 11, wherein said package further comprises:
a driver die comprising a first input contact pad, a second input contact pad, and a power supply contact pad; and
a synchronous rectifier die comprising a source region, a drain region and a gate region;
wherein said first lead is internally connected to said source region and to said first input contact pad, and wherein said second lead is internally connected to said drain region and to said second input contact pad, and further wherein said third lead is internally connected to said power supply contact pad.

13. The synchronous rectification circuit of claim 12, wherein said driver die further comprises an output contact pad internally connected to said gate region.

14. The synchronous rectification circuit of claim 12, wherein said driver die and said synchronous rectifier die are co-packaged as a stacked die package.

15. The synchronous rectification circuit of claim 12, wherein said driver die and said synchronous rectifier die are co-packaged as a die-to-die package.

16. A power supply adapter comprising a synchronous rectifier module in a single package, said package comprising:
a synchronous rectifier coupled between a secondary winding of an isolated converter and an output of said isolated converter; and
a driver controlling a switching function of said synchronous rectifier.
